(19) United States
(12) Patent Application Publication
(10) Pub. No.: US 2008/0174812 A1
(43) Pub. Date: Jul. 24, 2008

(54) IMAGE FORMING APPARATUS AND CONTROL METHOD THEREOF, AND HOST APPARATUS USABLE WITH IMAGE FORMING APPARATUS AND CONTROL METHOD THEREOF

(75) Inventors: Won-Q Lee, Suwon-si (KR); Woo-hwa Ha, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/970,630

(22) Filed: Jan. 8, 2008

(30) Foreign Application Priority Data
Jan. 22, 2007 (KR) 2007-6626

(51) Int. Cl. G06K 1/00

(52) U.S. Cl. 358/1.15

(57) ABSTRACT

A host apparatus usable with an image forming apparatus includes a data generating part that generates printing data of the image forming apparatus, a first host communicating part that performs local communication with the image forming apparatus, a second host communicating part that performs network communication with the image forming apparatus, and a host controller that receives network information of the image forming apparatus if the host apparatus is connected to the image forming apparatus via the first host communicating part, and transmits the printing data generated by the data generating part to the image forming apparatus via the second host communicating part based on the received network information.

### CROSS-REFERENCE TO RELATED APPLICATIONS

This application claims priority under 35 U.S.C. §119(a) from Korean Patent Application No. 10-2007-0006626, filed on Jan. 22, 2007 in the Korean Intellectual Property Office, the disclosure of which is incorporated herein by reference.

### BACKGROUND OF THE INVENTION

1. Field of the Invention

The represent general inventive concept relates to installation of a communication port of an image forming apparatus and a host apparatus, and more particularly, to an image forming apparatus that receives printing data via a network, a control method thereof, a host apparatus usable with the image forming apparatus, and a control method thereof.

2. Description of the Related Art

A host apparatus for an image forming apparatus such as a printer, a multi functional peripheral (MFP) and so on generates printing data adapted to the image forming apparatus and transmits the generated printing data to the image forming apparatus, and the image forming apparatus performs a printing operation based on the printing data. The host apparatus may be realized by a computer system.

The host apparatus and the image forming apparatus may be interconnected via a network such as a local area network (LAN). In this case, a network printer port (hereinafter abbreviated as “printer port”) of the image forming apparatus has to be installed in the host apparatus in order to transmit the printing data from the host apparatus to the image forming apparatus. An example of the printer port may include a standard TCP/IP Transmission Control Protocol/Internet Protocol (TCP/IP) port and other known ports.

The host apparatus may be provided with an operating system such as Windows and display a graphical user interface (GUI) 1 for installation of the printer port under support of the operating system, as illustrated in FIG. 1.

In such a conventional host apparatus, however, a user who wants to install a printer port has to input network information of an image forming apparatus (for example, a printer) to print an image on a print medium, such as a printer name and an Internet Protocol (IP) address.

Accordingly, if the user does not know the network information of the image forming apparatus, it is very difficult for the user to install the printer port of the image forming apparatus.

### SUMMARY OF THE INVENTION

The present general inventive concept provides an image forming apparatus, a control method thereof, a host apparatus usable with the image forming apparatus, and a control method thereof, which allow a user to install a network printer port of the image forming apparatus without difficulty.

Additional aspects of the present general inventive concept will be set forth in part in the description which follows and, in part, will be obvious from the description, or may be learned by practice of the present general inventive concept.

The foregoing and/or other aspects of the present general inventive concept can be achieved by providing a host apparatus of an image forming apparatus, comprising a data generating part that generates printing data of the image forming apparatus, a first host communicating part that performs local communication with the image forming apparatus, a second host communicating part that performs network communication with the image forming apparatus, and a host controller that receives network information of the image forming apparatus if the host apparatus is connected to the image forming apparatus via the first host communicating part, and transmits the printing data generated by the data generating part to the image forming apparatus via the second host communicating part based on the received network information.

The host controller may install a printer port of the image forming apparatus based on the received network information.

The host apparatus may further include a user input part that receives an instruction to install the printer port of the image forming apparatus from a user, wherein the host controller installs the printer port of the image forming apparatus according to the instruction from the user.

The host controller may select a type of the printer port of the image forming apparatus according to the instruction from the user.

The host apparatus may further include a display part that displays a graphical user interface (GU I) for installation of the printer port of the image forming apparatus.

The local communication may be based on one of line printing terminal (LPT), universal serial bus (USB) and IEEE 1394 systems.

The network communication may be based on a Transmission Control Protocol/Internet Protocol (TCP/IP) system.

The network information may include at least one of a printer name, an Internet Protocol (IP) address and a Media Access Control (MAC) address.

The foregoing and/or other aspects of the present invention can also be achieved by providing a control method of a host apparatus to be connected with the image forming apparatus through either of a local connection system or a network, the control method comprising receiving network information of the image forming apparatus from the image forming apparatus if the image forming apparatus is connected through the local connection system, and transmitting printing data to the image forming apparatus on the basis of the received network information if the image forming apparatus is connected through the network.

The control method may further include installing a printer port of the image forming apparatus based on the received network information.

The installing the printer port of the image forming apparatus may include receiving an instruction to install the printer port of the image forming apparatus from a user; and installing the printer port of the image forming apparatus according to the instruction from the user.

The receiving the instruction from the user may include selecting the kind of the printer port of the image forming apparatus according to the instruction from the user.

The installing the printer port of the image forming apparatus may further include displaying a graphical user interface (GUI) for installation of the printer port of the image forming apparatus.

The local connection system may be based on one of line printing terminal (LPT), universal serial bus (USB) and IEEE 1394 systems.

The network may be based on a Transmission Control Protocol/Internet Protocol (TCP/IP).

The network information may include at least one of a printer name, an Internet Protocol (IP) address and a Media Access Control (MAC) address.

The foregoing and/or other aspects of the present invention can also be achieved by providing an image forming apparatus comprising an image forming part that forms an image based on printing data, a first printer communicating part that performs local communication with a host apparatus that generates the printing data; a second printer communicating part that performs network communication with the host apparatus, an information storing part in which network information for the network communication is stored, and a printer controller that transmits the network information to the host apparatus if the image forming apparatus is connected to the host apparatus via the first printer communicating part, and controls the image forming part to form an image based on the printing data transmitted from the host apparatus via the second printer communicating part.

The foregoing and/or other aspects of the present invention can also be achieved by providing a control method of an image forming apparatus to be connected with a host apparatus through either of a local connection system or a network, the control method comprising transmitting network information to the host apparatus connected through the local connection system; and forming an image based on the printing data transmitted from the host apparatus connected through the network.

The foregoing and/or other aspects of the present invention can also be achieved by providing an image forming system including an image forming apparatus to generate network information and to print an image, and a host apparatus to receive the network information through a first communication line from the image forming apparatus, and to transmit printing data corresponding to the image to the image forming apparatus through a second communication line different from the first communication line.

The first communication line may be a local communication line, and the second communication line may be a network.

The image forming apparatus may include a first print communicating part and a second print communicating part; and the host apparatus may include a first host communicating part connected to the first print communication part though the local communication line and a second host communicating part connected to the second print communicating part through the network.

The image forming apparatus may include a first print communicating part; and the host apparatus comprises a first host communicating part connected to the first print communicating part though the local communication line to transmit and receive the network information.

The image forming apparatus may include a second print communicating part; and the host apparatus may include a second host communicating part connected to the second print communicating part though the network to transmit and receive the printing data.

The image forming apparatus and the host apparatus may transmit and receive the network information through the first communication line regardless of a connection status of the second communication line between the image forming apparatus and the host apparatus.

The image forming apparatus and the host apparatus may transmit and receive the printing data through the second communication line regardless of a connection status of the second communication line between the image forming apparatus and the host apparatus.

The foregoing and/or other aspects of the present invention can also be achieved by providing an image forming apparatus of an image forming system, including a first print communicating part to communicate with an external host apparatus through a first communication line, a second print communicating part to communicate with the external host apparatus through a second communication line different from the first communication line, and a printer controller to transmit network information to the external host apparatus through the first print communicating part and the first communication line, and to receive printing data from the host apparatus through the second print communicating part and the second communication line.

The foregoing and/or other aspects of the present invention can also be achieved by providing a host apparatus of an image forming system, including a first host communicating part to communicate with an external image forming apparatus through a first communication line, a second host communicating part to communicate with the external image forming apparatus through a second communication line different from the first communication line, and a host controller to receive network information from the external image forming apparatus through the first print communicating part and the first communication line, and to transmit printing data to the external image forming apparatus through the second print communicating part and the second communication line.

The foregoing and/or other aspects of the present invention can also be achieved by providing a method of an image forming system, the method including transmitting network information from an image forming apparatus to a host apparatus through a first communication line, and transmitting printing data from the host apparatus to the image forming apparatus through a second communication line different from the first communication line

### BRIEF DESCRIPTION OF THE DRAWINGS

The above and/or other aspects of the present general inventive concept will become apparent and more readily appreciated from the following description of the embodiments, taken in conjunction with the accompanying drawings, in which:

FIG. 1 is a view illustrating an example of a conventional GUI for installation of a printer port;

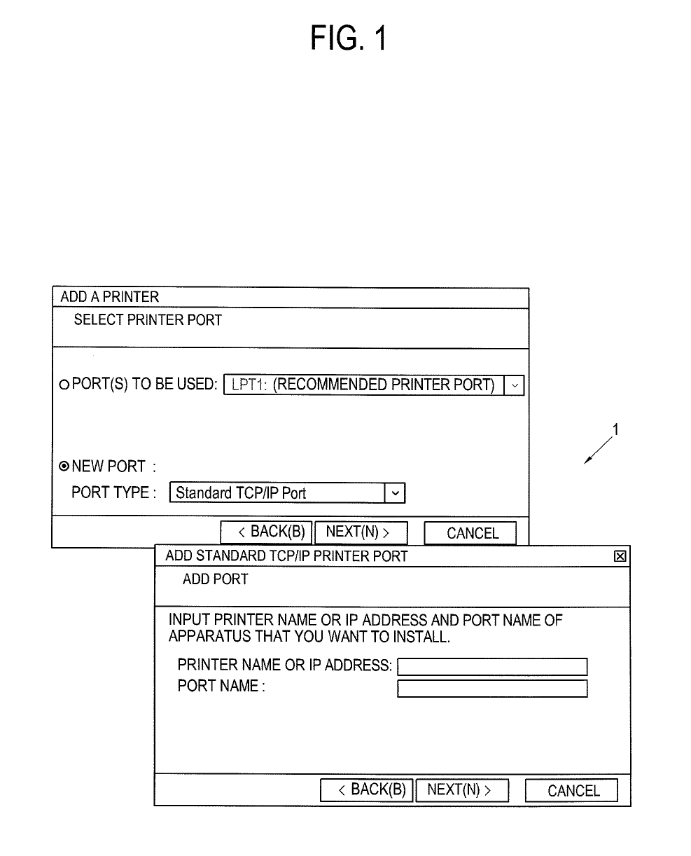

FIG. 2 is a block diagram illustrating an image forming apparatus and a host apparatus according to an exemplary embodiment of the present general inventive concept;

FIG. 3 is a flowchart illustrating an operation of a host controller according to an exemplary embodiment of the present general inventive concept;

FIG. 4 is a view showing an example of a GUI for installation of a printer port according to an exemplary embodiment of the present general inventive concept; and

FIG. 5 is a flowchart illustrating an operation of a printer controller according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

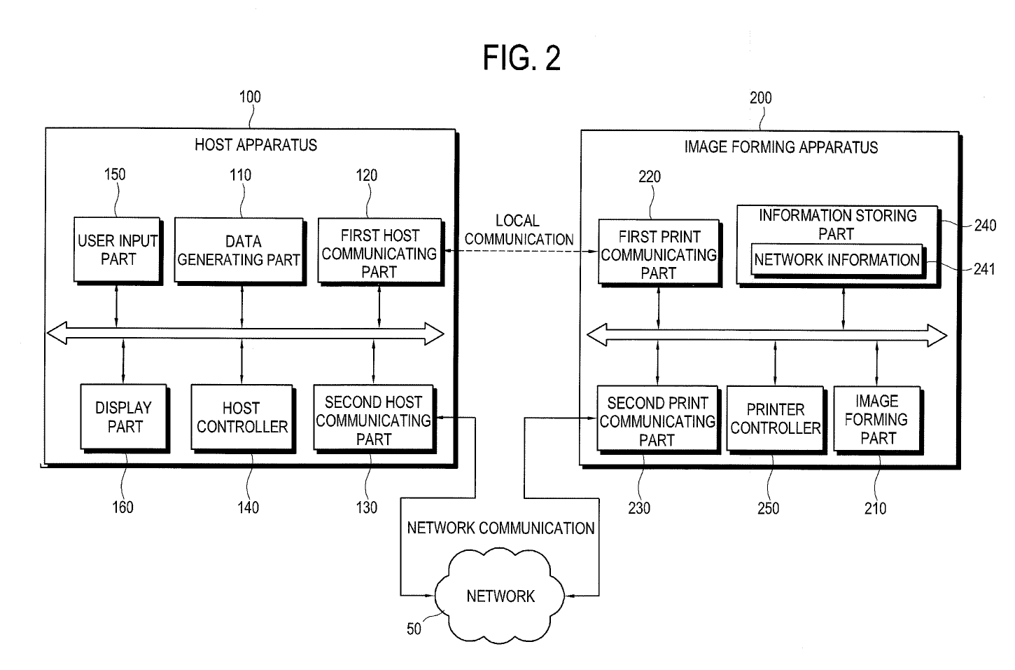

FIG. 2 is a block diagram illustrating an image forming apparatus 200 and a host apparatus 100 according to an exemplary embodiment of the present general inventive concept. The image forming apparatus 200 may be embodied by a printer, a multi function peripheral (MFP) and other known image forming apparatuses, and prints an image on a printing medium (or a recording medium) such as a sheet of paper based on printing data generated by the host apparatus 100. In the following description, the image forming apparatus 200 will be illustrated with a printer as an example.

The host apparatus 100, which may be embodied by a computer system, and generates the printing data usable in the image forming apparatus 200 and transmits the generated printing data to the image forming apparatus 200. An example of the host apparatus 100 may include a portable device such as a notebook personal computer, a cellular phone and a personal digital assistant (PDA). The image forming apparatus 200 and the host apparatus 100 can constitute an image forming system to install a communication port, to generate printing data, and to perform a printing operation of forming an image on a printing medium according to the printing data.

The host apparatus 100 and the image forming apparatus 200 may be interconnected by at least one of two paths. That is, the host apparatus 100 and the image forming apparatus 200 may be interconnected by a local connection system and/or via a network 50. The local connection system may include a parallel communication system such as an LPT (a Line Printing Terminal, a Line PrinTer or a Local Printer porT) and a serial communication system such as a Universal Serial Bus (USB), IEEE 1394 or the like. The network may be a local area network (LAN)

If the host apparatus 100 and the image forming apparatus 200 are interconnected by the local connection system, the host apparatus 100 receives network information of the image forming apparatus 200 from the image forming apparatus 200. The network information of the image forming apparatus 200 includes a printer name, an Internet Protocol (IP) address, and a Media Access Control (MAC) address of the image forming apparatus 200.

The host apparatus 100 transmits the printing data to the image forming apparatus 200 based on the received network information of the image forming apparatus 200.

As illustrated in FIG. 2, the host apparatus 100 includes a data generating part 110, a first host communicating part 120, a second host communicating part 130, a host controller 140, a user input part 150, and a display part 160.

The image forming apparatus 200 includes an image forming part 210, a first printer communicating part 220, a second printer communicating part 230, an information storing part 240 and a printer controller 250.

The data generating part 110 of the host apparatus generates the printing data adapted to the image forming apparatus 200. The image forming part 210 of the image forming apparatus 200 forms an image based on the printing data generated by the data generating part 110 of the host apparatus 100.

The first host communicating part 120 of the host apparatus 100 communicates with the first printer communicating part 220 of the image forming apparatus 200 by the local connection system (this communication is hereinafter referred to as “local communication”).

The second host communicating part 130 of the host apparatus 100 communicates with the second printer communicating part 230 of the image forming apparatus 200 via the network 50 (this communication is hereinafter referred to as “network communication”).

Network information 241 for the network communication between the second host communicating part 130 and the second printer communicating part 230 is stored in the information storing part 240 of the image forming apparatus 200. The network information 241 includes at least one of the printer name, the IP address and the MAC address of the image forming apparatus 200.

If the host controller 140 of the host apparatus 100 is connected to the image forming apparatus 200 via the first host communicating part 120, the host controller 140 receives the network information of the image forming apparatus 200 and transmits the printing data generated by the data generating part 110 to the image forming apparatus 200 via the second host communicating part 130 based on the received network information 241.

If the printer controller 250 of the image forming apparatus 200 is connected to the host apparatus 100 via the first printer communicating part 220, the printer controller 250 transmits the network information 241 stored in the information storing part 240 and controls the image forming part 210 to form an image based on the printing data transmitted from the host apparatus 100 via the second printer communicating part 230.

The host apparatus 100 and the image forming apparatus 200 can communicate with each other to transmit and receive the network information through the local communication line and the first communicating parts 120 and 220 so as to install the communication port, and to transmit and receive the printing data through the network 150 and the second communicating parts 130 and 230 so as to print an image corresponding to the printing image.

When the image forming apparatus 200 and the host apparatus 100 transmit and receive the network information through the local communication line and the first communicating parts 120 and 220, a connection status of the network 150 between the second communicating parts 130 and 230 may not affect the transmission of the network information between the host apparatus 100 and the image forming apparatus 200 through the local communication.

When the host apparatus 100 and the image forming apparatus 200 transmit and receive the network information through the network 150 and the second communicating parts 220 and 230, a connection status between the first communicating parts 120 and 130 may not affect the transmission of the network information between the host apparatus 100 and the image forming apparatus 200 through the network 150. That is, the host apparatus 100 and the image forming apparatus 200 transmit and receive the network information through the network 150 and the second communicating parts 220 and 230 regardless of the connection status between the first communicating parts 120 and 130 through the local communication.

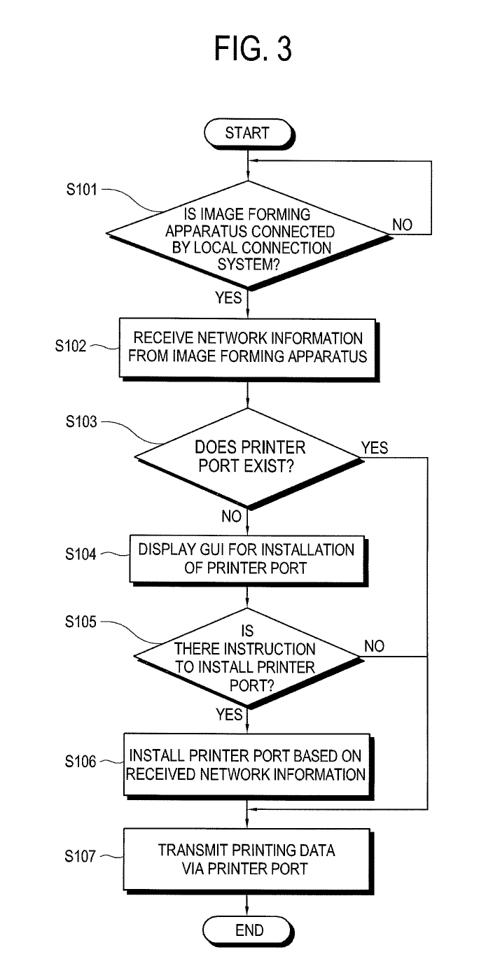

Hereinafter, the operation of the host controller 140 of the host apparatus 100 will be described in more detail with reference to FIG. 3. First, the host controller 140 checks whether or not the image forming apparatus 200 and the host apparatus 100 are interconnected by the local connection system at operation Si 01. Specifically, the host controller 140 checks whether or not the first printer communicating part 220 of the image forming apparatus 200 is connected to the first host communicating part 120 at the operation S101.

If it is checked at the operation S101 that the first printer communicating part 220 of the image forming apparatus 200 is connected to the first host communicating part 120, the host controller 140 controls the first host communicating part 120 to receive the network information 241 of the image forming apparatus 200 from the image forming apparatus 200 at operation S102.

Next, the host controller 140 checks whether or not a printer port of the image forming apparatus 200 exists in the host apparatus 100 based on the received network information 241 of the image forming apparatus 200 at operation S103. An example of the printer port of the image forming apparatus 200 may include a standard TCP/IP port and other known ports.

If the network information 241 of the image forming apparatus 200 and information of a corresponding printer port (for example, a name, kind and the like of a printer port) are pre-stored in a memory (not illustrated) provided within the host apparatus 100, the host controller 140 may determine at the operation S103 that there exists the printer port of the image forming apparatus 200 in the host apparatus 100.

If it is checked at the operation S103 that the printer port of the image forming apparatus 200 exists in the host apparatus 100, the host controller 140 completes its operation.

If it is checked at the operation S103 that the printer port of the image forming apparatus 200 does not exist in the host apparatus 100, the host controller 140 displays a GUI for installation of a printer port at operation S104. For example, the host apparatus 100 may further include a display part 160 that displays the GUI for installation of the printer port under control of the host controller 140.

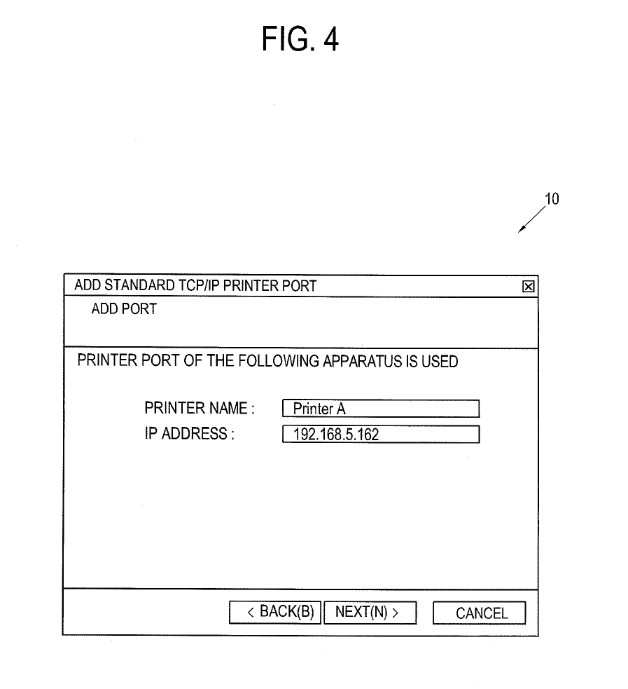

FIG. 4 is a view illustrating an example of a GUI 10 for installation of the printer port according to an exemplary embodiment of the present general inventive concept. Referring to FIGS. 2 through 4, the GUI 10 displays a printer name, an IP address and so on included in the network information 241 of the image forming apparatus 200 to allow a user to install the printer port of the image forming apparatus 200 corresponding to the displayed network information 241. In addition, the GUI 10 may include a user selection item for installation of the printer port or cancellation of installation of the printer port. A window of the GUI 10 is generated from the host apparatus 100 and displayed on the display part 160 or an external display part.

Next, the host controller 140 checks whether or not an instruction to install the printer port of the image forming apparatus 200 is inputted from a user at operation S105. The user input part 150 of the host apparatus 100 may receive data of the user's instruction to install the printer port and transmits the inputted user's instruction to the host controller 140.

If it is checked at the operation S105 that the instruction to install the printer port of the image forming apparatus 200 is not inputted from the user, operation S107 is performed without performing operation S106.

If it is checked at the operation S105 that the instruction to install the printer port of the image forming apparatus 200 is inputted from the user, the host controller 140 installs the printer port of the image forming apparatus 200 in the host apparatus 100 at the operation S106. In the operation S106, for example, the standard TCP/IP port may be installed as the printer port of the image forming apparatus 200. As an additional exemplary embodiment, a type of the printer port may be selected and determined by the user.

In the operation S106, the host controller 140 may install the print port of the image forming apparatus based on the network information 241 of the image forming apparatus 200 and information on the corresponding printer port, such as a name of printer port, which are stored in a predetermined memory provided within the host apparatus 100.

Next, if the image forming apparatus 200 is instructed to perform a printing operation, the host controller 140 controls the second host communicating part 130 to transmit the printing data to the image forming apparatus 200 via the printer port of the image forming apparatus 200 at operation S107. As an alternative exemplary embodiment, the operation S104 or the operation S105 may be omitted.

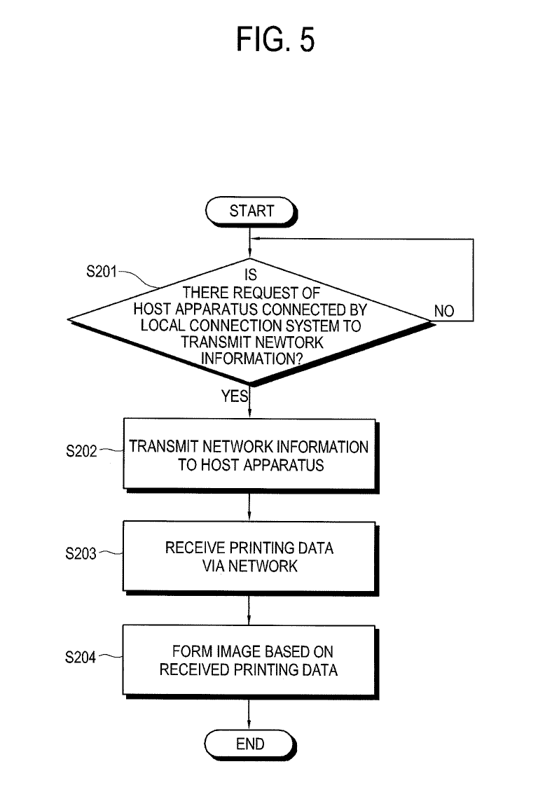

Hereinafter, the operation of the printer controller 250 of the image forming apparatus 200 will be described in more detail referring to FIG. 5. Referring to FIGS. 2 through 5, the printer controller 250 checks whether or not there is a request from the host apparatus 100, which is connected to the image forming apparatus 200 by the local connection system via the first printer communicating part 220, to transmit the network information 241 of the image forming apparatus 200 at operation S201.

If it is checked at the operation S201 that there is the request from the host apparatus 100 to transmit the network information 241 of the image forming apparatus 200, the printer controller 250 controls the first printer communicating part 220 so that the network information 241 of the image forming apparatus 200, which is stored in the information storing part 240, can be transmitted to the host apparatus 100 at operation S202.

Next, the printer controller 250 controls the second printer communicating part 230 to receive the printing data from the host apparatus 100 via the network 50 at operation S203.

Next, the printer controller 250 controls the image forming part 210 to form an image on a print medium based on the received printing data at operation S204.

Each of the host controller 140 and the printer controller 250 may be embodied by hardware and software such as a computer program. The hardware may include a ROM (not shown) in which a computer program is stored, a RAM (not shown) into which the computer program stored in the ROM is loaded, and a CPU (not shown) that executes the computer program loaded into the RAM. The computer program is programmed so that the CPU can perform the operation of the host controller 140 or the printer controller 250.

As apparent from the above description, the present invention provides an image forming apparatus, a control method thereof, a host apparatus for the image forming apparatus, and a control method thereof, which allow a user to install a network printer port of the image forming apparatus without difficulty.

According to the present general inventive concept, although a user does not know the network information of the image forming apparatus, such as a printer name, an IP address and the like, it is possible to improve user's convenience by automatically transmitting the network information to the host apparatus by only local connection between the host apparatus and the image forming apparatus, thereby allowing the user to install a printer port of the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A host apparatus usable with an image forming apparatus, the host apparatus comprising:
a data generating part that generates printing data of the image forming apparatus;
a first host communicating part that performs local communication with the image forming apparatus;
a second host communicating part that performs network communication with the image forming apparatus; and
a host controller that receives network information of the image forming apparatus if the host apparatus is connected to the image forming apparatus via the first host communicating part, and transmits the printing data generated by the data generating part to the image forming apparatus via the second host communicating part based on the received network information.

2. The host apparatus of claim 1, wherein the host controller installs a printer port of the image forming apparatus based on the received network information.

3. The host apparatus of claim 2, further comprising:
a user input part that receives an instruction to install the printer port of the image forming apparatus from a user,
wherein the host controller installs the printer port of the image forming apparatus according to the user instruction.

4. The host apparatus of claim 3, wherein the host controller selects a type of the printer port of the image forming apparatus according to the user instruction.

5. The host apparatus of claim 4, further comprising:
a display part that displays a graphical user interface (GUI) for installation of the printer port of the image forming apparatus.

6. The host apparatus of claim 1, wherein the local communication comprises one of line printing terminal (LPT), universal serial bus (USB) and IEEE 1394 systems.

7. The host apparatus of claim 1, wherein the network communication comprises a Transmission Control Protocol/Internet Protocol (TCP/IP) system.

8. The host apparatus of claim 1, wherein the network information comprises at least one of a printer name, an Internet Protocol (IP) address and a Media Access Control (MAC) address.

9. A control method of a host apparatus to be connected with the image forming apparatus through either of a local connection system or a network, the control method comprising:
receiving network information of the image forming apparatus from the image forming apparatus if the image forming apparatus is connected through the local connection system; and
transmitting printing data to the image forming apparatus on the basis of the received network information if the image forming apparatus is connected through the network.

10. The control method of claim 9, further comprising:
installing a printer port of the image forming apparatus based on the received network information.

11. The control method according to claim 10, wherein the installing of the printer port of the image forming apparatus comprises:
receiving an instruction to install the printer port of the image forming apparatus from a user; and
installing the printer port of the image forming apparatus according to the instruction from the user.

12. The control method of claim 11, wherein the receiving of the user instruction comprises selecting the kind of the printer port of the image forming apparatus according to the instruction from the user.

13. The control method of claim 12, wherein the installing of the printer port of the image forming apparatus further comprises displaying a graphical user interface (GUI) for installation of the printer port of the image forming apparatus.

14. The control method of claim 9, wherein the local connection system comprises one of line printing terminal (LPT), universal serial bus (USB) and IEEE 1394 systems.

15. The control method of claim 9, wherein the network comprises a Transmission Control Protocol/Internet Protocol (TCP/IP).

16. The control method according to claim 9, wherein the network information comprises at least one of a printer name, an Internet Protocol (IP) address and a Media Access Control (MAC) address.

17. An image forming system comprising:
an image forming apparatus to generate network information and to print an image; and
a host apparatus to receive the network information through a first communication line from the image forming apparatus, and to transmit printing data corresponding to the image to the image forming apparatus through a second communication line different from the first communication line.

18. The image forming system of claim 19, wherein the first communication line comprises a local communication line, and the second communication line comprises a network.

19. The image forming system of claim 20, wherein:
the image forming apparatus comprises a first print communicating part and a second print communicating part; and
the host apparatus comprises a first host communicating part connected to the first print communication part though the local communication line and a second host communicating part connected to the second print communicating part through the network.

20. The image forming system of claim 20, wherein:
the image forming apparatus comprises a first print communicating part; and
the host apparatus comprises a first host communicating part connected to the first print communicating part though the local communication line to transmit and receive the network information.

21. The image forming system of claim 22, wherein:
the image forming apparatus comprises a second print communicating part; and
the host apparatus comprises a second host communicating part connected to the second print communicating part though the network to transmit and receive the printing data.

22. The image forming system of claim 19, wherein the image forming apparatus and the host apparatus transmit and receive the network information through the first communication line regardless of a connection status of the second communication line between the image forming apparatus and the host apparatus.

23. The image forming system of claim 19, wherein the image forming apparatus and the host apparatus transmit and receive the printing data through the second communication line regardless of a connection status of the second communication line between the image forming apparatus and the host apparatus.

24. An image forming apparatus of an image forming system, comprising:
a first print communicating part to communicate with an external host apparatus through a first communication line;
a second print communicating part to communicate with the external host apparatus through a second communication line different from the first communication line; and
a printer controller to transmit network information to the external host apparatus through the first print communicating part and the first communication line, and to receive printing data from the host apparatus through the second print communicating part and the second communication line.

25. A method of an image forming system, the method comprising:
transmitting network information from an image forming apparatus to a host apparatus through a first communication line; and
transmitting printing data from the host apparatus to the image forming apparatus through a second communication line different from the first communication line.
